(19) United States
(12) Patent Application Publication
(10) Pub. No.: US 2007/0237191 A1
(43) Pub. Date: Oct. 11, 2007

(54) Devices for high power, high-repetition rate, broadly tunable coherent radiation, and its applications

(76) Inventors: James D. Kafka, Palo Alto, CA (US); James Clark, Campbell, CA (US); David E. Spence, Mountain View, CA (US)

Correspondence Address: BIOTECHNOLOGY LAW GROUP;C/O PORTFOLIOIP, PO BOX 52050, MINNEAPOLIS, MN, 55402, US

(21) Appl. No.: 11/700,366

(22) Filed: Jan. 30, 2007

Related U.S. Application Data
(60) Provisional application No. 60/763,803, filed on Jan. 30, 2006.

(51) Int. Cl. H01S 3/10

(52) U.S. Cl. 372/20; 372/21

(57) ABSTRACT

The present application is directed to various embodiments of laser systems which include a laser oscillator and a pump source configured to produce coherent light at high repetition rates and with short pulse durations, wherein the output from the laser oscillator is then amplified in a laser amplifier, which includes a pump source, the output from the laser amplifier has increased average and peak power, but preserves the short pulse duration and high repetition rate of the laser oscillator.

### CROSS-REFERENCE TO RELATED APPLICATION

The present application claims priority to U.S. Provisional Patent Application Ser. No. 60/763,803, filed Jan. 30, 2006, the entire contents of which are hereby incorporated by reference in its entirety herein

### BACKGROUND

Presently, there is an ongoing need for broadly tunable sources of coherent radiation for applications in physics, chemistry, biology, engineering, and technology. Further, there is a need for high-repetition rate, broadly tunable sources with their associated benefits, such as superior stability and potential for high throughput in commercial applications. While lasers sources can provide coherent radiation either directly or through frequency conversion, the output wavelength is often fixed within a narrow range that is dependant on the properties of the laser gain material. Even so-called tunable laser materials are limited in the wavelengths they can produce by the properties of the physical atomic, ionic, or molecular energy transitions that are involved in the laser process.

Attractive alternative sources for tunable radiation are based on optical parametric processes in nonlinear materials, such as optical parametric oscillation (OPO), optical parametric amplification (OPA), and optical parametric generation (OPG). These do not involve physical electronic transitions. As such, the wavelengths produced by devices utilizing these materials and systems are only limited by properties such as the transparency or phase-matching range of the associated nonlinear crystal.

While these optical parametric devices have addressed some needs in the market, a number of shortcomings have been identified. For example, one disadvantage inherent to any nonlinear processes is that the efficiency is peak power dependant. As a result, the optical parametric systems often require a high peak power pump source such as a modelocked or Q-switched source. Consequently, in the prior art, optical parametric sources have used large oscillator/amplifier systems which are inherently complex and not particularly robust. Additionally, to get the required high peak power, the pump sources have usually operated at relatively low repetition rates of a few tens of kilohertz or less.

In light of the foregoing, there is an ongoing need for high power, high-repetition rate, broadly tunable coherent radiation sources. There is a further need for high peak and average power, tunable coherent radiation sources configured to provide coherent radiation having short pulse durations in the hundreds of femtosecond regime. There is yet a further need for high power, tunable, short pulse duration coherent radiation sources configured to coherent radiation at high repetition rates greater than about 1 MHz.

### SUMMARY

In one embodiment a laser system includes a laser oscillator and a pump source configured to produce coherent light at high repetition rates and with short pulse durations. The output from the laser oscillator is then amplified in a laser amplifier, which includes a pump source; the output from the laser amplifier has increased average and peak power, but preserves the short pulse duration and high repetition rate of the laser oscillator. The output from the laser amplifier then produces tunable radiation with short pulse durations and high repetition rates through nonlinear frequency conversion.

In another embodiment, the laser amplifier includes a solid-state gain material that is pumped by a diode pump source. In yet another embodiment, the laser amplifier includes a fiber amplifier that is pumped by a diode pump source. In yet another embodiment, the laser system includes a pulse stretcher that increases the pulse duration prior to amplification in the laser amplifier. In yet another embodiment, the laser system includes a pulse compressor that compresses the pulse durations after amplification in the laser amplifier.

In another embodiment, the laser system includes at least one nonlinear conversion device configured to produce tunable, coherent radiation. In yet another embodiment, the at least one nonlinear conversion device is configured as an optical parametric conversion device. In another embodiment the optical parametric conversion device is configured as an optical parametric oscillator. In another embodiment, the optical parametric conversion device is configured as an optical parametric generator. In another embodiment the optical parametric conversion device is configured as an optical parametric amplifier.

In another embodiment, a portion of the output from the laser amplifier is frequency doubled in a nonlinear crystal, and used to pump the at least one optical parametric conversion device. In another embodiment, a portion of the output of the laser amplifier is used to seed the at least one optical parametric conversion device. In another embodiment, the seed for the at least one optical parametric conversion device is provided by a frequency conversion device that includes a nonlinear material.

These features of embodiments will become more apparent from the following detailed description when taken in conjunction with the accompanying exemplary drawings.

### BRIEF DESCRIPTION OF DRAWINGS

Various embodiments of high power, high-repetition rate, broadly tunable optical radiation sources will be explained in more detail by way of the accompanying drawings, wherein:

FIG. 1 shows a schematic diagram of an embodiment of a high power, high-repetition rate, broadly tunable optical radiation source;

FIG. 2 shows a schematic diagram of an embodiment of a high power, high-repetition rate, broadly tunable optical radiation source having a pulse stretcher and pulse compressor therein;

FIG. 3 shows a schematic diagram of an embodiment of a high power, high-repetition rate, broadly tunable optical radiation source having a nonlinear conversion system therein;

FIG. 4 shows a schematic diagram of an embodiment of a high power, high-repetition rate, broadly tunable optical radiation source having a harmonic conversion system and seed generator therein; and

FIG. 5 shows an embodiment of a high power, high-repetition rate, broadly tunable optical radiation source having multiple laser amplifiers.

### DETAILED DESCRIPTION

Solid-state lasers have a wide range of applications in physics, chemistry, biology, engineering, and technology. Often, especially in research environments, but also in many industrial applications, it is desirable to have a single source that is capable of providing a broad range of output parameters, so that a single system can be used for many different applications. For example, it may be desirable to have a single source that can provide a broad range of output wavelengths. This can be accomplished in various ways. The most direct solution is to use a laser gain material that is tunable, however, the tunability is often limited, and inevitably the performance of the system is compromised as the operating wavelength approaches the edges of the tuning range.

In the alternative, nonlinear optical processes may be used to provide the tunability. In particular, optical parametric processes such as optical parametric oscillators, optical parametric amplifiers, and optical parametric generators can be used. These processes are, among other things, peak power dependant and, therefore, typically require modelocked pump sources, although Q-switched pumps can also be used. However, prior art embodiments of such systems tend to operate at low repetition rates in the kilohertz range, and require large and complicated pump sources. As a consequence of the low repetition rate, the speed and/or throughput of experiments or process are often limited. In addition, there can be increased noise on the output of the system.

Recently, Brunner, et al. in Optics Letters Vol. 29, 1921 (2004) demonstrated a system based on optical parametric processes that was specifically designed for generating red, green, and blue light for laser projection systems. This system operated at 57 MHz and was pumped with a high-power modelocked oscillator based on a Yb:YAG thin-disk laser. Although the pump laser operated at high average powers (˜80 W), it generated relatively long pulses (˜700 fs). As a result, the peak power was limited, and the repetition rate was limited to the range less than 60 MHz. In addition, the system was not tunable, but produced fixed wavelengths appropriate for red-green-blue generation.

More recently, A. Steinmann, et al. in Advanced Solid-State Photonics 2006, paper TuC6, demonstrated a Yb:KYW oscillator that was cavity dumped and used as a pump source for an optical parametric amplifier. In this case the repetition rate was fixed at about 1 MHz by the cavity dumping process. An alternative setup was described by T. V. Andersen, et al. in Advanced Solid-State Photonics 2006, paper ME2, where a Yb:KGW seed oscillator and fiber amplifier were used to pump an optical parametric amplifier. This system also achieved a repetition rate of about 1 MHz. Both these systems have the advantage that they do not use a high-power oscillator, as the pump source, but both are limited in output power and in repetition rate.

By way of illustration, and without limitation, consider a modelocked pump laser that can produce pulses in the femtosecond regime at a repetition rate of about 80 MHz. Such a source based on, for example, a ytterbium doped tungstate crystal, can produce pulses having durations of less than about 200 fs with average powers of about several hundred milliwatts, at wavelengths near about 1040 nm. Such a source has been amplified in a regenerative amplifier (Spectra-Physics Eclipse™) and used to pump an optical parametric amplifier, but at repetition rates of only a few kilohertz. Using an ytterbium doped fiber amplifier, this source can be amplified to high average powers of about tens of Watts, while preserving the high repetition rate. The output can then be used for a nonlinear or other process.

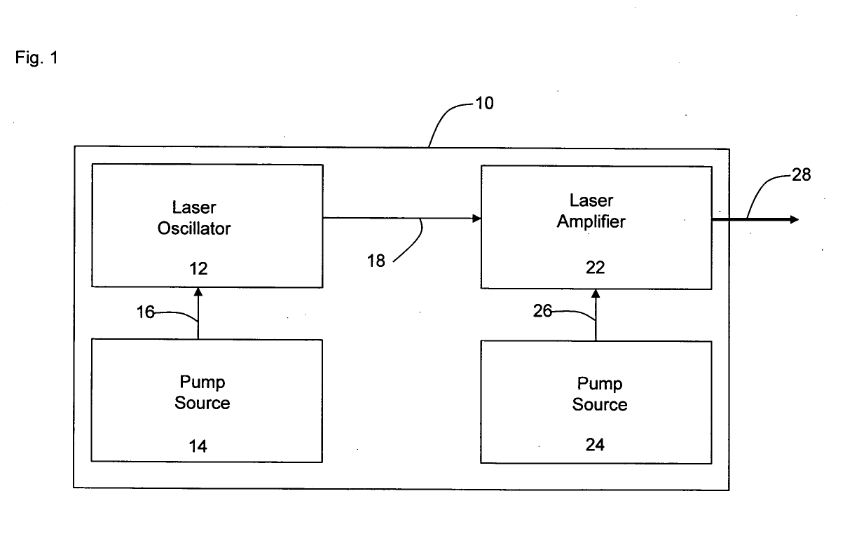

FIG. 1 shows an embodiment of a high power, high-repetition rate, tunable coherent radiation source. As shown, the radiation source 10 includes at least one laser oscillator 12 and at least one pump source 14 configured to provide pump radiation to the laser oscillator 12. For example, the pump source 14 may be configured to provide optical radiation, electric current, or optical radiation and electrical current to the laser oscillator. As such, the pump source 14 is in communication with the laser oscillator 12. In the illustrated embodiment the pump source 14, is coupled to the laser oscillator 12 via at least one pump coupling apparatus 16. For example, the coupling apparatus 16 may comprise one or more optical fibers. In the alternative, the pump source 14 may communicate with the laser oscillator 12 via electrical conduits, optical conduits, free space communication systems, and the like. Further, any variety and number of devices may be used to form the pump source 14 including, without limitation diode lasers, fiber lasers, alternate laser sources, electric power supplies, light sources, and the like.

Referring again to FIG. 1, the laser oscillator 12 is in communication with at least one laser amplifier 22. For example, the laser oscillator 12 may be configured to irradiate one or more oscillator output signals 18 at one or more wavelengths to the laser amplifier 22. The oscillator output signal 18 may be irradiated to the laser amplifier via free space, or, in the alternative, via one or more optical conduits such as fiber optic devices.

As shown in FIG. 1, the laser amplifier 22 may have at least one pump source 24 coupled thereto via at least one pump coupling apparatus 26. In the particular embodiment shown in FIG. 1, the pump source 24 comprises a diode pump source, although any variety of pump sources 24 may be herewith. For example, the pump source 24 may comprise one or more diode lasers, fiber lasers, alternate laser sources, electric power supplies, light sources, and the like. In one embodiment, the pump source 14 and pump source 24 comprise identical pump source. In the alternative, the type of pump source 14 may differ from the type of pump source 24. For example, pump source 14 may comprise a diode laser array while the pump source 24 may comprise a fiber laser device.

Referring again to FIG. 1, in the illustrated embodiment, the laser oscillator 12 and laser amplifier 22 are coupled to separate pump sources 14, 24, respectively. In an alternate embodiment, the laser oscillator 12 and laser amplifier 22 may be pumped by a single pump source configured to provide pump radiation to the laser oscillator 12 and the laser amplifier 22. It will also be apparent that the pump coupling apparatus 16 and/or 26 may include additional elements including, without limitation, at least one or a combination of lenses, mirrors, waveplates, apertures, beam splitters, prisms, volume Bragg gratings, optical fibers, and the like. Further, the radiation source 10 may include multiple laser oscillators 12 and multiple laser amplifiers 22 as required.

In the embodiment shown in FIG. 1, the laser oscillator 12 comprises a ytterbium-doped tungstate laser oscillator, having a laser gain material such as Yb:KGW, Yb:KYW, KYbW, and the like. Those skilled in the art will appreciate that any variety of alternate laser oscillators may be used herewith. Optionally, the pump source 14 may comprise a diode pump source consisting of at least one InGaAs laser diode emitting at a wavelength of about 940 nm, with an average output power of about 2 W. Optionally, the pump source 14 may be configured to emit any wavelength between about 400 nm to about 1700 nm as desired. For example, the pump source 14 may be configured to emit optical radiation at a wavelength of about 980 nm. Further, the laser oscillator 12 may be modelocked using a modelocking device such as, but not limited to, a semiconductor saturable absorber mirror, an acousto-optic modulator, a nonlinear mirror, and the like, and may be configured to produce laser pulses of less than about 200 fs at a repetition rate of about 80 MHz. In one embodiment, the laser oscillator 12 produces an average output power of about 500 mW at a wavelength of about 1040 nm. As shown in FIG. 1, the output from the at least one laser oscillator 12 is optically coupled into at least one laser amplifier 22 and amplified therein.

Referring again to FIG. 1, the laser amplifier 22 may comprise a ytterbium-doped fiber amplifier configured to amplify the output from the laser oscillator 12. Optionally, the laser oscillator 12, the laser amplifier 22, or both may be constructed of any variety and combination of materials, including, without limitation, Nd:YVO₄, Nd:YAG, Nd:YLF, Nd:Glass, Ti:sapphire, Cr:YAG, Cr.Forsterite, Yb:YAG, Yb:KGW, Yb:KYW, Yb:glass, KYbW, and YbAG, an apatite structure crystal, a semiconductor material, and an optical fiber. In one embodiment, the laser amplifier 22 may be pumped with about 60 W of pump power at a wavelength of about 976 nm from pump source 24. During use, the laser oscillator 12 outputs an oscillator output signal 18 to the laser amplifier 22 which amplifies the signal and outputs an amplified output signal 28. For example, in one embodiment the laser amplifier 22 amplifies the output of the laser oscillator 12 by up to about five hundred times (500×). In another embodiment, the laser amplifier 22 amplifies the output of the laser oscillator 12 by up to about three hundred times (300×). In another embodiment, the laser amplifier 22 amplifies the output signal 18 from the laser oscillator 12 by up to about one hundred times (100×). In one embodiment, the output 28 from laser amplifier 22 can have an average amplified output power of about 40 W. In an alternate embodiment, the output 28 of the laser amplifier 22 is from about 15 W to about 100 W.

Referring again to FIG. 1, in one embodiment the laser amplifier 22 preserves the high repetition rate of laser oscillator 12, so that the output 28 of laser amplifier 22 also has a high repetition rate. In one embodiment, the repetition rate is about 40 MHz to about 75 MHz. In an alternate embodiment, the repetition rate may be from about 60 MHz to about 80 MHz. In another embodiment, the repetition rate may be from about 75 MHz to about 150 MHz. In a specific embodiment, the repetition rate is about 80 MHz. Optionally, the laser amplifier 22 may comprise a bulk amplifier, which includes a bulk crystal as the laser gain material. Alternatively, laser amplifier 22 may comprise multiple laser amplifiers that can include fiber laser amplifiers, bulk laser amplifiers or a combination of bulk and fiber laser amplifiers.

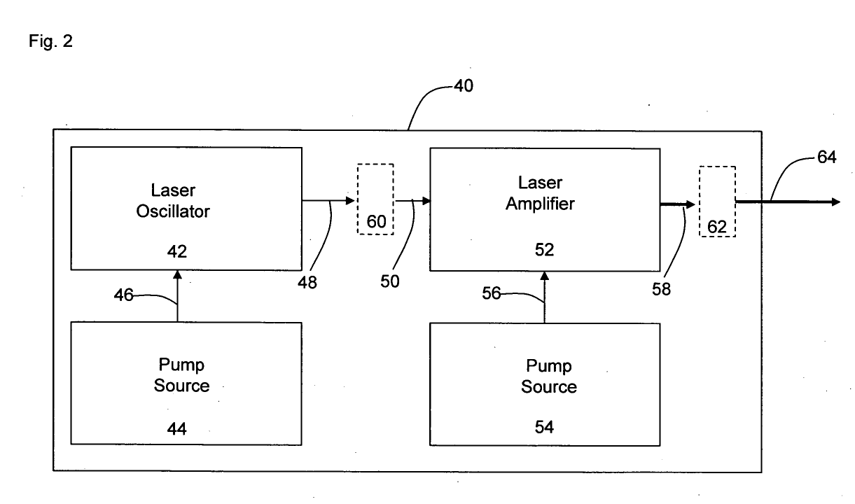

In order to manage the nonlinear effects in laser amplifier 22, which can cause spectral and/or temporal pulse distortions in the output 28 of laser amplifier 22, the optical system 10 of FIG. 1 can include any variety of additional optical components as well. For example, FIG. 2 shows an embodiment of an optical system 40 having at least one pulse stretcher 60 and at least one pulse compressor 62 device therein. As shown, the optical system 40 includes a laser oscillator 42 pumped by a pump source 42 via a pump source conduit 44. Like the embodiment illustrated in FIG. 1, the optical system also includes a laser amplifier 52 pumped by a pump source 54 via a pump source conduit 54. At least one pulse stretcher 60 is positioned between the laser oscillator 42 and the laser amplifier 52. In one embodiment, laser oscillator 42 is optically coupled to a pulse stretcher 60. In the illustrated embodiment, the pulse stretcher 60 comprises at least one dispersive optical element such as a diffraction grating or similar optical element. In another embodiment, the pulse stretcher 60 comprises at least two dispersive optical elements configured to temporally broaden the output 48 pulses of laser oscillator 42, by having different transit times for different wavelength components of the modelocked pulses. In one embodiment, the dispersive elements may be configured to introduce a wavelength dependent optical path length difference into the system. As a result, the output 48 of laser oscillator 42 is temporally chirped in time. As such, the pulse stretcher 60 outputs a stretched signal 50 having a broader pulse duration and a lower peak power as compared with output 48. It will be apparent that the pulse stretcher 60, can consist of many alternate dispersive optical elements, and may even consist of a suitable combination of different dispersive optical elements. Exemplary dispersive optical elements can include elements such as, but not limited to, reflection gratings, transmission gratings, volume Bragg gratings, fiber Bragg gratings, optical fibers, bulk optically dispersive elements, prisms, and the like. Other optical elements may also be included in the pulse stretcher as required. Such other optical elements can include elements such as, but not limited to, plane mirrors, curved mirrors, lenses, apertures, waveplates, filters, spatial light modulators, acousto-optic programmable dispersive filters, and the like. The output 50 from pulse stretcher 60 can then be amplified in laser amplifier 52 with reduced detrimental nonlinear effects than would otherwise be present without pulse stretcher 60.

Referring again to FIG. 2, the stretched signal 50 is amplified by the laser amplifier 52 and emits an amplified output 58 of laser amplifier 52 which is often also temporally broadened and chirped in addition to broadened and chirp effect of the pulse stretcher 60. Optionally, the laser amplifier 52 may be coupled to a pulse compressor 62. The pulse compressor 62 is configured to substantially reverse the results of the combined pulse distortion effects from the combination of the pulse stretcher 60 and laser amplifier 52. In one embodiment, the pulse compressor 62 can include various optical elements including, but not limited to dispersive optical elements and other optical elements similar to those used for pulse stretcher 60. The output 64 from pulse compressor 62 has a shorter pulse duration that it would have without pulse compressor 62. In another embodiment, the pulse stretcher 60 and pulse compressor 62 may be positioned within the laser oscillator 42, the laser amplifier 52, or both.

Optionally, the optical system 40 of FIG. 2 includes pulse compressor 62, but does not include pulse stretcher 60. In this embodiment the output parameters of laser oscillator 42 are chosen to result in substantially parabolic pulse propagation in laser amplifier 52, as described by, for example, V. I. Kruglov, et al. in JOSA B, Vol. 19, page 461 ff. (2002). Examples of output pulse parameters of laser oscillator 42 that are suitably chosen are parameters such as, but not limited to, pulse duration, average power, peak power, pulse bandwidth, temporal chirp, frequency chirp, repetition rate, and the like. Parabolic pulse propagation in laser amplifier 52 results in the pulses at the output 58 of laser amplifier 52 having a substantially linear temporal chirp. These pulses can then be effectively temporally compressed in pulse compressor 62, producing an output 64 having a short pulse duration, high power and retains the high repetition rate of laser oscillator 42.

In one embodiment, the output peak power from the laser oscillator 42 shown in FIG. 2 is about 60 kW and the pulse duration is less than about 200 fs, although those skilled in the art will appreciate that any desired output peak power and pulse duration may be obtained. For example, higher peak power (e.g. 200 kW) can optionally be provided as well, depending on the exact details of laser oscillator 12. These parameters can be high enough to result in appreciable nonlinear effects in laser amplifier 52, such as, but not limited to self-phase modulation and dispersive pulse broadening. These effects can broaden the pulse duration and spectral bandwidth of the output 58 of laser amplifier 52 to a point where the pulses are no longer useful for applications such as, but not limited to, nonlinear frequency conversion. Other detrimental effects such as stimulated Raman scattering and the like can also occur in laser amplifier 52.

In another embodiment of laser system 40 includes a pulse stretcher 60, but does not include a pulse compressor 62. The pulse stretcher 60 may be configured to condition or otherwise modify the output parameters of laser oscillator 42 for amplification in laser amplifier 52 such that the output 58 of laser amplifier 52 will have the desired parameters. In one example, intended for illustration and without limitation, the output 48 of laser oscillator 42 is coupled into pulse stretcher 60. The pulse stretcher 60 outputs a stretched signal 50 having a temporal chirp to that will substantially counteract the effects of self-phase modulation in laser amplifier 52. As a result, the output 58 of laser amplifier 52 will have a substantially narrower bandwidth, than it would have in the absence of pulse stretcher 60.

Again, by way of illustration and without limitation, consider a modelocked pump laser operating at about 80 MHz and producing pulses in the picosecond regime. Such a source can be based on, for example, neodymium-doped vanadate (Nd:YVO₄) and can produce pulses having durations of about few picoseconds and an average output power of several Watts. In one embodiment, the oscillator 42 can be amplified in a fiber amplifier 52 to increase the average power available. In an alternative embodiment, the oscillator 42 can be amplified in a bulk amplifier 52 using at least a second Nd:YVO₄ gain material. The output from both of these amplifier systems can then be used for nonlinear or other process.

Referring again to the embodiment shown in FIG. 1, the laser oscillator 12 may comprise a neodymium-doped vanadate laser oscillator, consisting of a Nd:YVO₄ laser gain material. Optionally, the laser oscillator 12, the laser amplifier 14, or both may be constructed of any variety and combination of materials, including, without limitation, Nd:YVO₄, Nd:YAG, Nd:YLF, Nd:Glass, Ti:sapphire, Cr:YAG, Cr.Forsterite, Yb:YAG, Yb:KGW, Yb:KYW, Yb:glass, KYbW, and YbAG, an apatite structure crystal, a semiconductor material, and an optical fiber. Pump source 14 is a diode pump source consisting of at least one InGaAsP laser diode emitting at a wavelength of about 808 nm, with an average output power of about tens of Watts. Laser oscillator 12 is modelocked using a modelocking device such as, but not limited to, a semiconductor saturable absorber mirror, an acousto-optic modulator, a nonlinear mirror, and the like, and produces pulses of about 10 ps at a repetition rate of about 80 MHz, although those skilled in the art will appreciate that pulse from about 10 fs to about 400 ps may be produced by the laser oscillator 12. Further, the repetition rate may range from about 10 MHz to about 500 MHz. Laser oscillator 12 produces an average output power of from about 1 W to about 100 W at a wavelength of about 1064 nm. For example, the laser oscillator 12 may have an average output power of about 4 W. The output 18 from laser oscillator 12 is coupled into laser amplifier 22 and amplified therein. Laser oscillator 12 can optionally include a low doped Nd:YVO₄ gain material as described in U.S. Pat. No. 6,504,858 and U.S. Pat. No. 6,185,235, both of which are incorporated herein by reference. Further, the laser oscillator 12 can optionally have an optimized pump source 14 as described in U.S. patent application Ser. No. 60/714,576, the entire contents of which are incorporated herein by reference, emitting at a wavelength of about 806 nm.

Referring again to FIG. 1, the laser amplifier 22 may comprise a fiber laser amplifier based on a ytterbium-doped fiber similar to those discussed in previous embodiments herein. Alternatively, laser amplifier 22 may comprise a bulk laser amplifier based on a gain material such as, but not limited to, neodymium-doped vanadate, similar to laser oscillator 12. Alternatively, laser amplifier 22 can include multiple laser amplifiers. Optionally, the laser amplifier 22 may include fiber laser amplifiers, bulk laser amplifiers, or a combination of bulk and fiber laser amplifiers.

In the particular embodiment where laser amplifier 22 includes at least one bulk laser amplifier, the laser amplifier 22 includes at least one laser gain material such as, but not limited to, neodymium-doped vanadate. The laser amplifier 22 may optionally include one or more laser gain materials. In one embodiment, the laser gain materials may have the same properties or different properties, as required. Examples of such properties include, but are not limited to, doping, length, size, shape, orientation, temperature, and the like.

Referring again to FIG. 1, wherein laser amplifier 22 comprises a neodymium-doped vanadate laser amplifier, the laser amplifier 22 is coupled to a diode pump source 24 via a pump coupling apparatus 26 comprising a fiber pump coupling apparatus. At least one diode pump source 24 including at least one diode emitting pump light at about 808 nm with an average power from about 5 W to about 50 W may be used. In one specific embodiment, the pump source 24 outputs an average power of about 30 W. In one embodiment, the pump source 24 includes two such diodes such that the total pump power supplied to laser amplifier 22 is from about 20 W to about 150 W. In one specific embodiment, the total pump power is about 60 W. Optionally, one, two, or more such pump sources can be included as required. Further, the laser amplifier 22 may comprise one or more laser amplifiers 22 each having their own pump source 24 and pump coupling apparatus 26. The laser amplifier 22 may include low doped Nd:YVO₄ gain material as described in U.S. Pat. No. 6,504,858 and U.S. Pat. No. 6,185,235, the contents of which are incorporated in its entirety herein. The laser amplifier 22 can optionally include at least one optimized pump source 24 as described in U.S. patent application Ser. No. 60/714,57, emitting at a wavelength from about 500 nm to 1000 nm, the contents of which are all hereby incorporated by reference in their entirety. In one embodiment, the pump source 24 emits radiation at about 806 nm.

The optical system 10 may be configured to output radiation any a variety of average powers. For example, in one embodiment the laser oscillator 12 produces an average power of about 10 W. Thereafter, the laser amplifier 22 amplifies the output of laser oscillator 12 to produce an output 28 of about 30 W. In an alternate embodiment of optical system 10, the laser oscillator 12 produces an output 18 of about 3 W. Thereafter, the laser amplifier 22 amplifies the output 18 of laser oscillator 12 to produce and output 28 of about 25 W. In an alternative embodiment of optical system 10, laser amplifier 22 produces an output 28 of greater than about 30 W. The amplified output 28 has a pulse duration of from about 1 ps to about 40 ps and a repetition rate of about 40 MHz to about 200 MHz. In another embodiment the amplified output 28 has a pulse duration of from about 10 ps to about 100 ps and at a repetition rate of about 40 MHz to about 200 MHz. In a specific embodiment, the amplified output 28 has a pulse duration of about 10 ps and a high repetition rate of about 80 MHz, similar to the output 18 of laser oscillator 12, but at higher powers. The amplified output 58 of laser system 10 can then be used to for a nonlinear processes or other application.

In another embodiment, the laser amplifier 22 comprise a fiber laser amplifier, and may include a pulse compressor 62, as illustrated in FIG. 2. Laser system 40 in FIG. 2 may also optionally include a pulse stretcher 60 positioned between the laser oscillator 42 and the fiber laser amplifier 52. Thus, the laser system 40 may be configured to provide a high output power and a high repetition rate. The output 64 of laser system 40 can then be used to for a nonlinear or other process. In one embodiment where laser amplifier 52 comprises a fiber laser amplifier, the output parameters of laser oscillator 42 may optionally be chosen to result in substantially parabolic pulse propagation in laser amplifier 52.

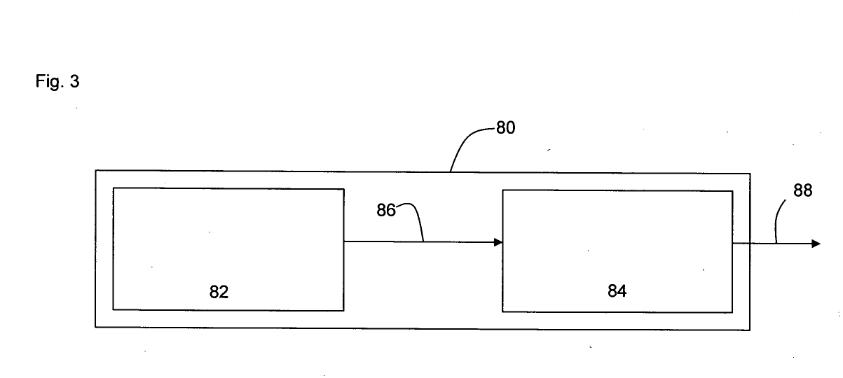

FIG. 3 shows another embodiment of an optical system 80. As shown, the optical system 80 comprises a laser system 82 substantially similar to the optical system 10 of FIG. 1 and/or the optical system 40 of FIG. 2. As shown in FIG. 3, laser system 82 is optically coupled to at least one nonlinear conversion system 84. The nonlinear conversion system 84 converts the output 86 of laser system 82 at a first wavelength to at least one converted output 88 at a second wavelength through one or more than one nonlinear optical processes. Any variety of nonlinear and/or wavelength conversion systems 84 may be used with the present system. Exemplary embodiments of nonlinear conversion system 84 may include, one or a combination of more than one of the processes such as, but not limited to, second harmonic conversion, third harmonic conversion, forth harmonic conversion, fifth harmonic conversion, higher than fifth harmonic conversion, sum-frequency conversion, difference-frequency conversion, optical parametric conversion, optical parametric generation, optical parametric amplification, optical parametric oscillation, continuum generation, and the like.

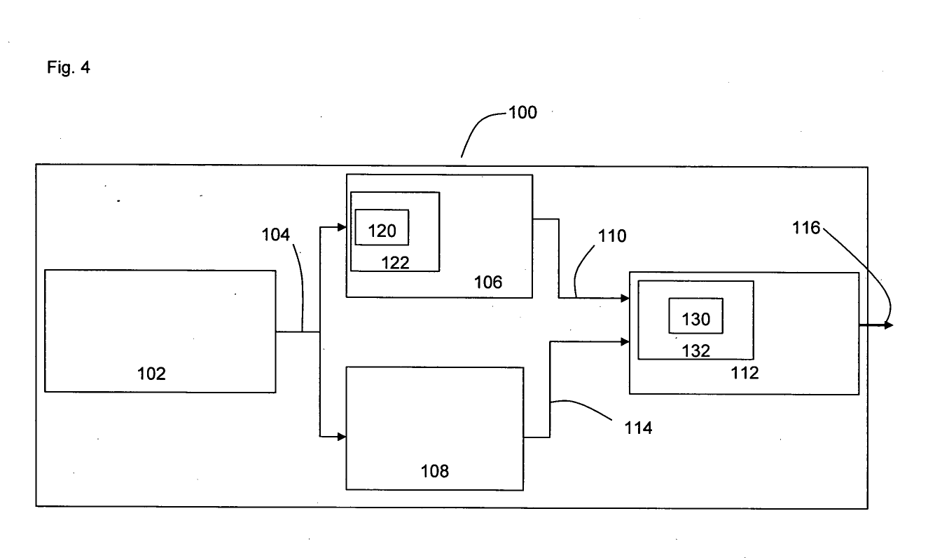

Referring again to FIG. 3, in one embodiment the nonlinear conversion system 84 includes an optical parametric amplifier, although those skilled in the art will appreciate that an optical parametric oscillator may also be used. FIG. 4 shows in greater detail an embodiment of nonlinear conversion system 100. As shown, the optical system 100 includes at least one laser system 102 that is substantially similar to optical system 10 in FIG. 1 or optical system 40 in FIG. 2. The laser system 102 irradiates an output 104 which is directed into a harmonic generator device 106 and a seed generator 108. A first portion of the output 104 of the laser system 102 is coupled into a harmonic generator 106. A second portion of the output 104 of laser system 42 is coupled into a seed light generator 108. The output 110 of the harmonic generator 106 is coupled into an optical parametric amplifier 112. The output 114 of seed light generator 108 is also coupled into the optical parametric amplifier 112. Optionally, an optical parametric amplifier 112 may be in communication with one or more pump lasers (not shown) configured to provide pump radiation thereto. In another embodiment, the optical parametric amplifier 112 may be in direct communication with laser system 102, without using the harmonic generator 106, in which case optical output beams 104 and 110 are substantially similar. Optical parametric amplifier 112 produces at least one output 116. Typically, the output 116 of the optical parametric amplifier 112 consists of more than one output. Optionally, the optical system 100 may contain multiple optical parametric amplifiers 112, optical parametric oscillators, or both.

The harmonic generator 106 may include at least one nonlinear crystal 120. In one embodiment of the optical system 100, the nonlinear crystal 120 is LBO. As shown, the harmonic generator 106 converts a portion of the output 104 of laser system 102 to a harmonic thereof. For example, the harmonic output 110 may comprise a second harmonic of the laser system output 104. In one embodiment the output 104 of the laser system 102 is at a wavelength of about 1040 nm, while the output 110 of the harmonic generator 106 has a wavelength of about 520 nm. The harmonic generator 106 is configured to convert a portion of the output 104 of laser system 102 to harmonic output 110 with an efficiency of more than about 40%. In one embodiment, the harmonic generator 106 can convert a portion of the output 104 of laser system 10 to harmonic output 110 with an efficiency of more than about 50%. As an example, in the embodiment where the nonlinear crystal 120 comprises LBO, the nonlinear crystal 120 may be non-critically phase-matched. As such it is kept temperature stabilized at a temperature of about 150 ° C. In this embodiment, the harmonic generator 106 also includes a temperature-stabilized device 122 to stabilize the temperature of nonlinear crystal 120.

The length of the nonlinear crystal 120 included in the harmonic generator 106 should be suitably chosen to minimize detrimental effects such as, but not limited to, group-velocity walkoff, as the output 104 of laser system 102 can have short pulse durations, and broad spectral bandwidths. The length of the nonlinear crystal 120 can range from about 10 μm to about 100 mm. In one embodiment, the length of the nonlinear crystal 120 is about 5 mm. It will be apparent that other nonlinear crystals 120 can be included in the harmonic generator 106. Examples of other nonlinear crystals can include, but are not limited to, LBO, BBO, KTP, KTA, RTA, CTA, BiBO, CLBO, LiNbO3, LiTaO₃, and the like. It will also be apparent that the nonlinear crystal 120 included in the harmonic generator 106 can be birefringently phase matched or quasi-phase matched.

The optical system 100 of FIG. 4 also includes a seed light generator 108. In one embodiment, the seed light generator 108 comprises a white light generator. In this embodiment, the seed light generator 108 receives a portion of the output 104 of laser system 102 and generates a white light continuum as an output 114. The white light continuum output 114 is coupled into the optical parametric amplifier 112 and acts as a seed source for the optical parametric amplification process. Various elements can be used as a white light seed light generator 108, and include, but are not limited to, sapphire, glass, fused silica, calcium fluoride, YAG, single-mode fiber, photonic crystal fiber, tapered fiber, and the like. Other devices can also be used for the white light seed light generator 108, such as the Continuum Generation Chip available commercially from Mesophotonics Ltd, Southampton, England. Optionally, a portion of the output 110 of harmonic generator 106 can be used to generate the seed light from the seed light generator 114.

In the alternative, the seed light generator 108 may comprise an optical parametric generator. Such an optical parametric seed light generator 108 takes a portion of the output 104 of laser system 102, or optionally of the output 110 from harmonic generator 106, and generates a different wavelength through optical parametric fluorescence, that is then used as a seed for optical parametric amplifier 112. Such an optical parametric seed light generator 108 can optionally use a periodically polled material such as, but not limited to, LiNbO3, LiTaO3, KTP, isomorphs of KTP, and the like, or of bulk nonlinear materials such as, but not limited to, LBO, BBO, KTP, KTA, RTA, CTA, BiBO, CLBO, and the like. Optical parametric amplifier 112 takes the output 114 of the optical parametric seed light generator 108 and amplifies it therein. The wavelength of the optical parametric seed light generator 108 is determined by the properties of the optical parametric seed light generator device. Examples of properties that determine the wavelength of the optical parametric seed light generator include, but are not limited to, temperature, phase matching angle, polling period, input wavelength, and the like.

Referring again to FIG. 4, the optical system 100 also includes an optical parametric amplifier 112. The optical parametric amplifier 112 may include at least one nonlinear crystal 130 that amplifies a portion of the output 114 of seed light generator 108 to produce at least one output 116. Usually output 116 consists of more than one output, that are referred to as the signal and idler. In a particular embodiment, the optical parametric amplifier 112 is pumped with the output 110 from harmonic generator 106, and transfers energy from the high-power wavelength 110 to the lower power wavelength 114 of the seed light generator 108, through the nonlinear process of optical parametric amplification. Optionally, the optical parametric amplifier 112 is directly pumped with a portion of the output 104 from laser system 102.

As shown in FIG. 4, the optical parametric amplifier 112 includes at least one nonlinear crystal 120. Any variety of nonlinear crystal 120 may be used, including, for example, LBO. The output beam 104 from laser system 102 has a wavelength of about 1040 nm and the output wavelength 110 from the harmonic generator 106 has a wavelength of about 520 nm. The output 114 from the seed light generator 108 has a wavelength of about 600-1500 nm. In the embodiment where the nonlinear crystal 120 is LBO, nonlinear crystal 120 can be non-critically phase matched by maintaining it at the appropriate temperature. As such, optical parametric amplifier 112 can include a temperature-stabilized oven 132 to maintain the nonlinear crystal 120 at the appropriate temperature. By varying the temperature of the nonlinear crystal 120, the wavelength of the output 116 of optical parametric amplifier 112 can be varied. For example, by changing the temperature of the nonlinear crystal 120 between about 100 ° C. and 150 ° C. the output 116 of the optical parametric amplifier 112 can be varied from about 700 nm to about 1100 nm.

In the embodiment where the nonlinear conversion system 84 of FIG. 3 is an optical parametric oscillator, the laser system 102 of FIG. 4 irradiates an output 104 which is directed into a harmonic generator device 106 that is substantially similar to those described elsewhere herein. The output 110 is coupled into an optical parametric oscillator 112. In another embodiment, the optical parametric oscillator 112 may be in direct communication with laser system 102, without using the harmonic generator 106, in which case optical output beams 104 and 110 are substantially similar. Optical parametric oscillator 112 includes at least one nonlinear crystal 130. Any variety of nonlinear crystal 130 may be used, including, for example, LBO. In this embodiment, the nonlinear crystal 130 can be non-critically phase-matched by maintaining it at the appropriate temperature. As such, optical parametric oscillator 112 can include a temperature stabilized oven 132 to maintain the nonlinear crystal 130 at the appropriate temperature. By varying the temperature of the nonlinear crystal 130, the wavelength of the output 116 of optical parametric amplifier 112 can be varied. Optical parametric oscillator 112 produces at least one output 116. Typically, the output 116 of the optical parametric oscillator 112 consists of more than one output. Optionally, the optical system 100 may contain multiple optical parametric oscillators 112, optical parametric amplifiers, or both.

It will be apparent that other nonlinear crystals 130 can be used with optical parametric generator 112 as well. Examples of other nonlinear crystals can include, but are not limited to, LBO, BBO, KTP, KTA, RTA, CTA, BiBO, CLBO, LiNbO3, LiTaO3, AgGaSe2, AgGaS2, and the like. It will also be apparent that the nonlinear crystal 130 included in optical parametric generator 112 can be birefringently phase matched or quasi-phase matched. In various embodiments of the optical system 100, the nonlinear crystal 130 of optical parametric generator 112 can be angle tuned. As such, the angle and the temperature of the nonlinear crystal 130 can be varied to control the phase matching of the optical parametric amplification process. The phase matching of the optical parametric generation process in optical parametric generator 112 can optionally be controlled using quasi-phase matching.

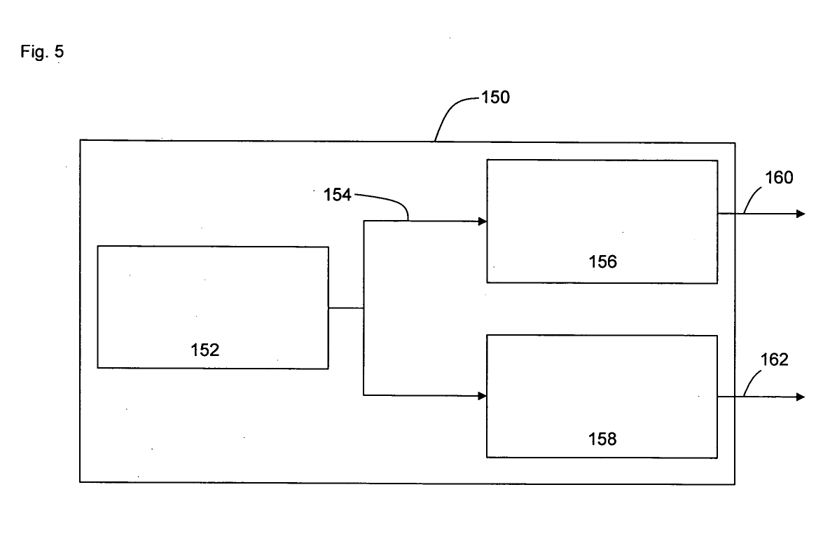

FIG. 5 shows another embodiment of an optical system. As shown, the optical system 150 includes at least one laser system 152. The laser system 152 includes an optical system substantially similar to the optical system 10 of FIG. 1 and/or the optical system 40 of FIG. 2. Optionally, the laser system 52 may include a harmonic generator substantially similar to harmonic generator 106 of FIG. 4. Optionally, the laser system 152 may also include a seed light generator substantially similar to seed light generator 108 of FIG. 4. The output 154 of the laser system 152 includes at least a pump beam, similar to the output beam 110 in FIG. 4, and optionally, a seed beam similar to the output 114 from the seed light generator 108 in FIG. 4. A first portion of the output beam 154 from laser system 152 is used to pump a first optical parametric amplifier 156 and a second portion of the output beam 154 from laser system 152 is used to pump a second optical parametric amplifier 158. Those skilled in the art will appreciate that multiple optical parametric oscillators may be used in addition to or in place of the optical parametric amplifiers 156, 158. First optical parametric generator 156 has at least one output beam 160, and second optical parametric generator 158 has at least one output beam 162. The output beams 160 and 162 can have short pulse durations and high repetition rates. The output beams 160 and 162 may also optionally be tunable in wavelength. The output pulses in beams 160 and 162 are synchronized in time as they share a common laser system 152 for the pump and seed pulses 154. The output beams 160 and 162 can optionally be independently tunable in wavelength. Optionally, the wavelength tunability of output beams 160 and 162 can be further increased by directing them to additional harmonic conversion or other nonlinear conversion devices as required.

Referring again to FIG. 3, in all of the embodiments described herein, the output 88 of the optical system 80 has at least a high repetition rate greater than about 1 MHz. Other desirable features of the output 88 of the optical system 80 can include, but are not limited to, high average power, high peak power, short pulse duration, at least one tunable wavelength, and the like. The resulting output 88 can be used for applications where at least one of these features is desirable. The high repetition rate enables the application to be carried out more quickly and/or with better signal to noise than would otherwise be possible. Examples of applications where such an optical system 80 could be utilized include, but are not limited to, micro machining, ablation, inspection, spectroscopy, multi-photon excitation, medical applications, and the like. Additionally, for certain applications the output 88 of nonlinear conversion system 84 includes multiple output beams. The multiple output beams include pulses that are temporally synchronized and can optionally be independently tunable.

As shown in FIG. 3, in one embodiment of optical system 80, the output 88 can be delivered to the work piece using a suitable system of optical elements including, without limitation, lenses, mirrors, apertures, beam splitters, prisms, fibers, and the like. In another embodiment the system of optical elements can be included as part of a mechanically articulated delivery system, such as, without limitation, a robot arm. In yet another embodiment the system of optical elements can be included a part of a fiber delivery system. Such a delivery system has been described in U.S. Pat. No. 6,822,978, U.S. Pat. No. 6,389,198, and U.S. Pat. No. 6,185,235, all of which are incorporated herein by reference.

The foregoing description of various embodiments of diode laser systems has been presented for purposes of illustration and description. It is not intended to be exhaustive or to limit the invention to the precise forms disclosed. Obviously, many modifications and variations will be apparent to practitioners skilled in this art.

What is claimed is:

1. A high repetition, tunable laser system, comprising:
at least one laser system configured to provide at least one optical signal having a repetition rate of about 1 MHz or greater at a selected wavelength;
at least one harmonic generator in optical communication with the laser system;
at least one seed light generator in optical communication with the laser system; and
at least one nonlinear conversion system configured to receive the optical signals from the harmonic generator and the seed light generator and output at least one amplified optical signal at at least one wavelength configured to be selectable and tunable by a user.

2. The device of claim 1 wherein the nonlinear conversion system comprises at least one optical parametric amplifier.

3. A high repetition laser system, comprising:
at least one laser system configured to provide at least one optical signal having a repetition rate of about 60 MHz or greater at a selected wavelength;
at least one harmonic generator in optical communication with the laser system;
at least one seed light generator in optical communication with the laser system; and
at least one nonlinear conversion system configured to receive the optical signals from the harmonic generator and the seed light generator and an output at least one amplified optical signal at at least one predetermined wavelength.

4. A high repetition, synchronized tunable laser system, comprising:
at least one laser system configured to provide at least one optical signal having a repetition rate of about 300 KHz or greater at a selected wavelength;
at least one harmonic generator in optical communication with the laser system;
at least one seed light generator in optical communication with the laser system; and
a first and at least a second nonlinear conversion system each configured to separately receive the optical signals from the harmonic generator and the seed light generator and separately output at least one amplified optical signal at least one wavelength configured to be selectable and tunable by a user.

5. The device of claim 4 wherein at least one of the nonlinear conversion systems comprises at least one optical parametric oscillator.

6. The device of claim 4 wherein the first and second nonlinear conversion systems are configured to output the same wavelength.

7. The device of claim 4 wherein the first and second nonlinear conversion systems are configured to output different wavelengths.
